(19) United States
(12) Patent Application Publication
(10) Pub. No.: US 2012/0261459 A1
(43) Pub. Date: Oct. 18, 2012

(54) LASER METALWORKING USING REACTIVE GAS

(76) Inventor: Gerald J. Bruck, Oviedo, FL (US)

(21) Appl. No.: 13/084,608

(22) Filed: Apr. 12, 2011

(51) Int. Cl. B23K 31/02; B23K 35/34

(52) U.S. Cl. 228/178; 228/198

(57) ABSTRACT

A method of metalworking a substrate (10) previously strengthened in a gas heat treatment to form precipitates throughout an entire volume of the substrate (10), where the precipitates have an active chemical element incorporated during the gas heat treatment. The method includes: melting a portion of the substrate (10) during a full penetration metalworking process to form a molten portion (12); generating a metalworking atmosphere (22) having a supply of an active chemical element in a gas state during the metalworking process; exposing the molten portion (12) to the metalworking atmosphere (22); and cooling the molten portion (12) while maintaining exposure to the metalworking atmosphere (22) to form a solidified portion (36) comprising precipitates comprising the active chemical element, where the precipitates are present throughout an entire volume of the solidified portion (36), and thereby re-strengthen the entire volume of the solidified portion (36).

### FIELD OF THE INVENTION

The invention relates to post heat-treatment metalworking of an alloy that has previously been strengthened in a heat treatment with reactive gasses. Specifically, the invention relates to exposing a subsequently metalworked portion of the previously strengthened substrate to reactive gasses during the subsequent metalworking process.

### BACKGROUND OF THE INVENTION

The recent introduction of advanced high temperature alloys that are strengthened by reactive gas heat treatment poses significant advantages as well as limitations. An example, but not meant to be limiting, of such a material is NS-163™ manufactured by Haynes International of Kokomo, Ind., USA. As manufactured, this material is very ductile, formable, and weldable. After forming and weld fabrication assemblies are then given a high temperature nitrogen atmosphere heat treatment to optimize mechanical properties. In this material the heat treatment causes nitridation throughout the part and results in considerable strengthening. The strengthening mechanism is largely attributed to the precipitation of titanium and columbium nitrides. This processing has limitations, however. For example, heat treatment strengthening is limited to relatively thin substrates, e.g. about 2 mm (0.08″) maximum. Also, after fabrication and heat treatment the assembly cannot be further processed by forming or welding because it is fully strengthened and not amendable to such metalworking. However, there are occasions where it would be advantageous to form and/or metalwork the material subsequent to the heat treatment. Consequently, there remains room in the art for improvement.

### BRIEF DESCRIPTION OF THE DRAWINGS

The invention is explained in the following description in view of the drawings that show:

FIG. 1 illustrates a full penetration metalworking process using reactive gas shielding.

FIG. 2 is a cross-sectional view of a repair made using the process of FIG. 1.

FIG. 3 is a cross-sectional view of an assembly made using the process of FIG. 1.

### DETAILED DESCRIPTION OF THE INVENTION

The inventor has discovered an innovative method for re-strengthening an alloy, for example a cobalt or nickel based alloy, that has previously been strengthened via a gas reactive heat treatment, where the alloy has been subjected to a post strengthening metalworking that otherwise would reduce or eliminate the strengthening effect. Some post heat treatment metalworking processes, such as welding, have an effect of reducing or eliminating the strengthening effect resulting from the original heat treatment. It is thought that this happens when heat from the subsequent metalworking process reduces or eliminates precipitates that formed during the original heat treatment process. As a result, these precipitates may not be present in the portion of the previously strengthened substrate that has subsequently been metalworked, and so the portion of the substrate that has subsequently been metalworked may be weaker than a remainder of the substrate. The inventor has discovered that exposing the subsequently metalworked portion of the previously strengthened substrate to a reactive element that was present in the original strengthening process helps reform precipitates in the subsequently metalworked portion of the substrate. This re-strengthens the portion of the previously strengthened substrate that has subsequently been metalworked, leaving a substrate of uniform or near uniform strength.

In the case of Haynes NS-163™ alloy, the chemical composition of the substrate includes the elements titanium and columbium. When the NS-163™ alloy is heat treated in an atmosphere containing nitrogen the nitrogen combines with the titanium and/or columbium to form nitride precipitates throughout an entire volume of the NS-163™ alloy, and these precipitates strengthen the entire volume of the NS-163™ alloy. Conventional practice in metalworking alloys that are relatively reactive to the atmosphere requires that the metalworking be done in an inert environment. For example, argon and/or helium are typically used for shielding from the atmosphere during welding, cladding, or hardfacing stainless steels and alloys of nickel, cobalt, aluminum, and titanium. The objective of such shielding is to prevent excess oxidation and/or nitridation. For particular other reasons limited percentages of reactive (i.e. non-inert) shielding gasses are sometimes used or most especially combined with inert gasses. Certain processes, such as cladding or surface hardening, have used hydrogen as part of a metalworking atmosphere. However, the inventor is unaware of any full penetration metalworking process that utilizes a metalworking atmosphere that contains nitrogen in order to re-strengthen a substrate that has previously been strengthened through a heat treatment process utilizing a heat treatment atmosphere containing that same reactive element.

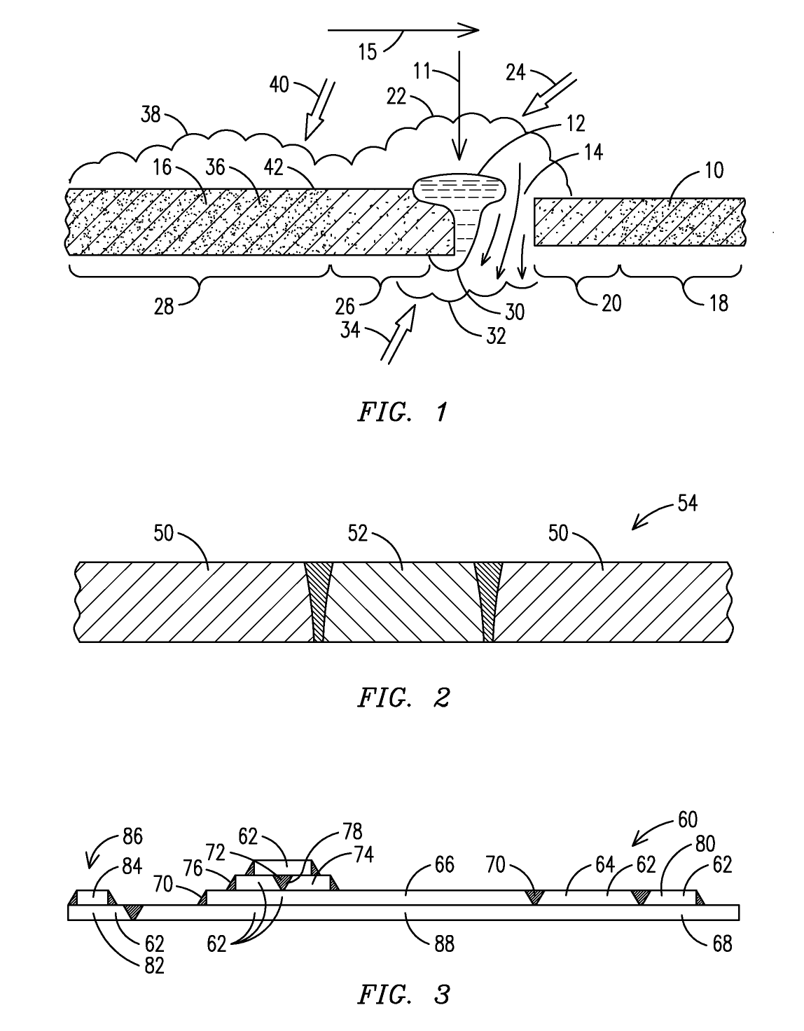

The method described herein can be used with various metalworking processes where a full thickness of the substrate is traversed by the metalworking process, e.g. a full penetration metalworking process, including but not limited to laser beam welding (LBW), plasma arc welding (PAW), tungsten inert gas (TIG) welding, and metal inert gas (MIG) welding etc. Such a full penetration welding process includes keyhole welding processes when joining two substrates edge-to-edge. As shown in FIG. 1, in keyhole welding processes an entire thickness of a portion of the substrate 10 is melted via an energy source 11 into a molten pool 12 (a.k.a. weld pool), and a hole 14 is formed through the entire thickness of the molten pool 12 of the substrate 10, and therefore an entire thickness of the substrate 10 itself. As the process traverses the substrate the molten pool 12 and associated hole 14 also traverse the substrate 10 in a direction of travel 15. Molten substrate solidifies into a weld bead 16 behind the hole 14. As the molten pool 12 heats and then melts previously hardened substrate material the strengthening effect that resulted from the heat treatment in the reactive gas atmosphere and indicated by strengthened region 18 diminishes or disappears altogether, as indicated by de-strengthened area 20.

In the inventive process a full volume of the molten pool is exposed to the reactive element in the metalworking atmosphere 22 via a shielding gas delivery path 24. The metalworking atmosphere 22 covers the top of the molten pool 12 and is also forced through the hole 14. This entrains the reactive element within the molten pool 12. This entrained reactive element then reacts with the elements in the substrate to strengthen the portion of the substrate that has been melted during the metalworking process. As the melted portion of the substrate cools the strengthening effect brought about by the reactive element begins to return, as indicated by first restrengthening region 26, and once cooled the re-strengthened region 28 is fully re-strengthened to the level of the substrate 10 prior to the metalworking process. As a result, the entire volume of the substrate 10, including that which was metalworked subsequent to the strengthening heat treatment, is strengthened to a uniform or near-uniform level.

The reactive element may also be delivered directly to a back side 30 of the weld as a backing gas 32 via a backing gas delivery path 34 during the metalworking process in order to entrain nitrogen in the molten material at the bottom of the weld pool, or molten material that has worked around to the back side 30 of the substrate. The reactive element may also be delivered to a solidified portion 36 of the subsequently metalworked portion as trailing gas 38 delivered via a trailing gas delivery path 40 so nitrogen may still be incorporated into a surface 42 of the solidified weld.

The nitrogen may likewise be delivered in various ways. For example, the nitrogen may be in gas form and independently delivered discretely or mixed with another gas to a molten pool. It may be a gas delivered discretely or mixed with another gas via a gas delivery path that is already incorporated into a welding process. Alternately it may be incorporated into a solid material such as a flux and released as a gas during the metalworking process.

When delivered independently to the molten pool, an existing metalworking process would simply need to be supplemented with a supply of nitrogen and a shielding gas delivery path 24 to deliver the nitrogen to the molten pool. When delivered by using an existing shielding gas delivery path 24, the nitrogen may take the place of gasses that formerly occupied that shielding gas delivery path, or it may be mixed with those gasses. For example, in LBW the gaseous nitrogen may be delivered via the incorporated shielding gas path or the incorporated optical assist/protective gas path. In PAW the gaseous nitrogen may be delivered via the incorporated shielding gas path or the incorporated orifice gas path. In TIG and MIG welding the gaseous nitrogen may be delivered via the incorporated shielding gas path. The nitrogen may also be delivered via a backing gas delivery path 34 or a trailing gas delivery path 40. When nitrogen is incorporated into a solid, for example a flux, it may be delivered in any manner acceptable for delivering a flux. For example, the nitrogen containing flux could be a coating on an electrode, or a delivered separately flux, such as a powder applied to the substrate prior to the metalworking process, or a powder mixed and delivered with or in place of powder flux conventionally used in the metalworking process.

Metalworking using the method disclosed herein may be used for a variety of purposes. For example, the method may be used in a welding process where two substrates are joined edge to edge. The method may also be used as a way to repair substrates, or as a way to build smaller substrates into larger assemblies.

When used to repair a component, as shown in FIG. 2, a substrate 50 may have a crack or other unwanted imperfection that is removed by excavation etc, leaving a hole into which a repair piece 52 may be inserted. Both the substrate 50 and repair piece 52 would have already been subjected to a strengthening heat treatment. The repair piece 52 may be joined to the substrate 52 using the method described herein, and the resulting repaired component 54 would then have all the strength of an original component.

FIG. 3 shows an assembly 60 with a plurality of substrate sheets 62. The assembly 62 indicates several ways the technique described herein may be applied to a repair or to creating a new, built-up new component. In terms of repair and as opposed to placing a repair piece 52 in a hole as disclosed in FIG. 2, a repair could be made where the repair piece 64 is positioned in an excavation of an assembly 60 and welded into place. This technique requires that the weld fully penetrate the repair piece 62, but it is not necessary that the weld fully penetrate the component 60.

The method disclosed herein may also be used to build-up several smaller substrate sheets 62 into a larger assembly 60. This can happen in any or all of a number of ways, including welding sheets 62 in layers to form a thicker assembly 60, and welding sheets 62 edge-to-edge to an assembly 60, or assemblies 60 edge-to-edge etc. To form a layered assembly 60, a second substrate 66 may be placed on top of a first substrate 68 and welded thereto. The welding may occur at the second substrate edges 70, or may occur through a substrate sheet, as indicated by weld 72 of third substrate sheet 74, which was welded to the second substrate at third substrate edges 76 and at a region 78 of the third substrate sheet 74 not at the edges. A fourth substrate sheet 80 has been shown as welded edge-to-edge to the second substrate sheet 64 and layered to the first substrate sheet 68. A fifth substrate sheet 82 has been to a sixth substrate sheet 84 to form a second mini assembly 86 that has been edge-to-edge welded to a first mini assembly 88 to form the assembly 60. Any or all of these techniques, or any technique that applies the teachings herein, may be used to form a complex assembly 60 of substrate sheets 62.

The present inventor has developed a technique for re-strengthening a previously strengthened substrate that has subsequently been metalworked. The technique utilizes existing technology in a way not yet practiced, and thus it will be easy to implement. Further, the method is inexpensive yet permits assembly and repair of materials in ways not previously possible, and thus it represents an improvement in the art.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

1. A method of metalworking a substrate previously strengthened in a gas heat treatment to form precipitates throughout an entire volume of the substrate, the precipitates comprising an active chemical element incorporated during the gas heat treatment, the method comprising:
melting a portion of the substrate during a full penetration metalworking process to form a molten portion;
generating a metalworking atmosphere comprising a majority by volume of an active chemical element in a gas state during the metalworking process;
exposing the molten portion to the metalworking atmosphere;
cooling the molten portion into an unrestrengthened solidified portion abutting the melted portion while exposing the unrestrengthened solidified portion to the metalworking atmosphere comprising the active chemical element to form a restrengthened solidified portion comprising precipitates comprising the active chemical element, wherein the precipitates are present throughout an entire volume of the solidified portion, and thereby re-strengthen the entire volume of the solidified portion.

2. The method of claim 1, wherein the full penetration metalworking process comprises a keyhole welding process and exposing the molten portion comprises directing the metalworking atmosphere through a keyhole formed during the keyhole welding process and out of a back side of the weld.

3. The method of claim 1, comprising directing the metalworking atmosphere comprising the active chemical element to a back side of the unrestrengthened solidified portion.

4. The method of claim 1, wherein the active chemical element comprises nitrogen and the precipitates comprise nitrides.

5. The method of claim 4, wherein the substrate comprises a cobalt or nickel base, and titanium and niobium, and the step of forming precipitates comprises forming at least one of titanium nitride and niobium nitride.

6. The method of claim 1, comprising using in the metalworking process at least one metalworking gas path leading to the metalworking atmosphere, and the method comprises delivering the active chemical element to the metalworking atmosphere via at least one metalworking gas path.

7. The method of claim 6, wherein the metalworking gas path is selected from a group consisting of a shielding gas path, a trailing gas path, a backing gas path, a powder assist gas path, and an optical path protecting gas path.

8. The method of claim 1, comprising melting a flux during the metalworking process to generate a flux gas constituting at least part of the metalworking atmosphere, the flux gas comprising the active chemical element.

9. The method of claim 1, comprising joining the substrate with a second substrate via the metalworking process, thereby forming a layered assembly.

10. The method of claim 1, wherein the substrate comprises a substrate chemical element that reacts with the active chemical element to strengthen the substrate, the method comprising delivering a filler powder comprising a filler chemical element that is the same as the substrate chemical element to the molten pool.

11. The method of claim 10, comprising adjusting a strengthening time of the heated portion by adjusting a concentration of the filler chemical element in the molten pool.

12. A method of metalworking a substrate comprising a precipitation-strengthened material comprising precipitates throughout an entire volume of the material, the precipitates comprising an active chemical element incorporated during a gas heat treatment, the method comprising:
melting a portion of a repair piece comprising a same material as the substrate during a metalworking process to form a full penetration molten portion of the repair piece;
generating a metalworking atmosphere comprising over 50 percent by volume a supply of the active chemical element in a gas state during the metalworking process;
exposing the molten portion to the metalworking atmosphere; and
cooling the molten portion into an unrestrengthened solidified portion abutting the melted portion while exposing the unrestrengthened solidified portion to the metalworking atmosphere comprising the active chemical element to form a restrengthened solidified portion comprising precipitates comprising the active chemical element, wherein the precipitates are present throughout an entire volume of the solidified portion, and thereby re-strengthen the entire volume of the solidified portion.

13. The method of claim 12, wherein the metalworking process uses a gas path, and the active chemical element is delivered to the molten portion via the gas path.

14. The method of claim 13, wherein the repair piece comprises at least one substrate chemical element that reacts with the active chemical element to strengthen the substrate, the method comprising delivering a filler powder comprising a filler chemical element that is the same as the substrate chemical element to the molten portion.

15. A method of metalworking a substrate comprising a precipitation-strengthened material comprising precipitates throughout an entire volume of the material, the precipitates comprising an active chemical element incorporated during a gas heat treatment, comprising:
welding a second substrate piece to a first substrate piece via a full penetration welding process of the second substrate piece, thereby forming a layered assembly comprising a thickness greater than a thickness of either substrate piece;
delivering a metalworking atmosphere consisting of the active chemical element in gas form to a welding atmosphere; and
exposing a melted portion and an unrestrengthened solidified portion abutting the melted portion to the welding atmosphere comprising the active chemical element to form a restrengthened solidified portion comprising precipitates comprising the active chemical element.

16. The method of claim 15, comprising welding a plurality of additional substrate pieces together to form a multi-layered assembly.

17. The method of claim 15, comprising welding an edge of an additional substrate piece to an edge of the assembly

18. The method of claim 15, comprising delivering the active chemical element via a gas path used in the welding.

19. The method of claim 15, comprising melting a flux during the welding to generate a flux gas constituting at least part of the welding atmosphere, the flux gas comprising the supply of the active chemical element.

20. The method of claim 15, wherein the substrate pieces comprise a chemical element that reacts with the active chemical element to strengthen the substrate sheets, the method comprising delivering a filler powder also comprising the chemical element.
